(19) United States
(12) Patent Application Publication
(10) Pub. No.: US 2008/0169940 A1
(43) Pub. Date: Jul. 17, 2008

(54) INTELLIGENT TRAFFIC CONTROL SYSTEM AND ASSOCIATED METHODS

(76) Inventors: Dae-Ryung Lee, Seoul (KR); Sang W. Lee, Kyeonggi-do (KR); Jonathan P. Munson, Putnam Valley, NY (US)

Correspondence Address: Ido Tuchman, 82-70 Beverly Road, Kew Gardens, NY, 11415, US

(21) Appl. No.: 11/622,789

(22) Filed: Jan. 12, 2007

(51) Int. Cl. G08G 1/09; G08G 1/00

(52) U.S. Cl. 340/928

(57) ABSTRACT

A system for traffic control that may include a controller carried by a vehicle, and the controller providing vehicle location data and vehicle specific data. The system may further include a server in communication with the controller, and the server defining at least one traffic zone based upon traffic flow data. In addition, the server may use the at least one traffic zone along with the vehicle location data and vehicle specific data to determine a fee for the vehicle to operate within the at least one traffic zone.

### FIELD OF THE INVENTION

The invention relates to the field of traffic control systems, and, more particularly, to intelligent traffic control systems and related methods.

### BACKGROUND OF THE INVENTION

The increasing number of vehicles traveling in most cities tends to create traffic problems due to the limited carrying capacity of a given city's transportation infrastructure. One method currently deployed of addressing this type of traffic problem is to attempt to limit the number of vehicles traveling in a city by using a traffic control system such as a tollgate system in which every driver pays a fixed fee at tollgates positioned throughout the city. However, a tollgate system may actually increase traffic congestion by impeding the flow of vehicles near the tollgate. In addition, most tollgate systems are expensive to install and operate.

An alternative traffic control method is to use a congestion pricing system whereby a vehicle operator pre-pays for the right to drive in a congestion zone. For example, the CORDON system currently deployed in London of the United Kingdom uses video cameras situated throughout the city to capture a vehicle's image and/or license plate for payment verification purposes. Any vehicle failing to pre-pay may be detected by the video cameras and such may be relayed to the system's enforcement authorities for further action.

A system such as the Cordon-type system has a number of limitations. For instance, a Cordon-type system tends to be very expensive because it requires a large number of high resolution video cameras be installed and maintained at every entry and exit into the area of control. Another limitation may be the inability of the Cordon-type system, due to the fixed position of the cameras, to adequately address a special event or an accident requiring special traffic control measures.

Unfortunately, the above described traffic control systems are limited in their ability to provide efficient and flexible traffic control at a reasonable price.

### SUMMARY OF THE INVENTION

In view of the foregoing background, it is therefore an object of the invention to provide a more efficient and flexible traffic control system at a reasonable price.

This and other objects, features, and advantages in accordance with the invention are provided by a system for traffic control. The system may include a controller carried by a vehicle, and the controller providing vehicle location data and vehicle specific data. The system may further include a server in communication with the controller, and the server defining at least one traffic zone based upon traffic flow data. In addition, the server may use the at least one traffic zone along with the vehicle location data and vehicle specific data to determine a fee for the vehicle to operate within the at least one traffic zone. Accordingly, a more efficient and flexible traffic control system is provided at a reasonable price.

The server may charge an account associated with the controller to pay the fee. The server may provide fee data based upon current traffic zone data to the controller prior to the vehicle entering the at least one traffic zone thereby permitting an operator of the vehicle to either enter or avoid the at least one traffic zone.

The server may monitor the at least one traffic zone and change in real-time the fee for the vehicle based upon a real-time change in the traffic flow data. The server may monitor the at least one traffic zone and dynamically change how the at least one traffic zone is defined based upon a real-time change in the traffic flow data.

The server may further determine the fee for the vehicle using at least one of distance traveled by the vehicle through the at least one traffic zone, amount of time the vehicle spends in the at least one traffic zone, what day the vehicle is in the at least one traffic zone, what time of day the vehicle is in the at least one traffic zone, what impact the vehicle has on the at least one traffic zone, and consideration of special events happening within the at least one traffic zone.

The controller may generate vehicle location data via at least one of a satellite based vehicle position determining system, a land based vehicle position determining system, and a sea based vehicle position determining system. The system may further comprise a plurality of traffic sensors in communication with the server, with the plurality of traffic sensors providing the traffic flow data.

Another aspect of the invention is a method for traffic control. The method may include defining at least one traffic zone based upon traffic flow data in a server, and determining vehicle location data and vehicle specific data by a controller carried by a vehicle. The method may further include using the at least one traffic zone along with the vehicle location data and vehicle specific data at the server to determine a fee for the vehicle to operate within the at least one traffic zone.

### BRIEF DESCRIPTION OF THE DRAWINGS

FIG. 1 is a schematic block diagram of the traffic control system in accordance with the invention.

FIG. 2 is a partial schematic diagram representing a hypothetical street view of a deployed traffic control system of FIG. 1.

FIG. 3 is a flowchart illustrating method aspects according to the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

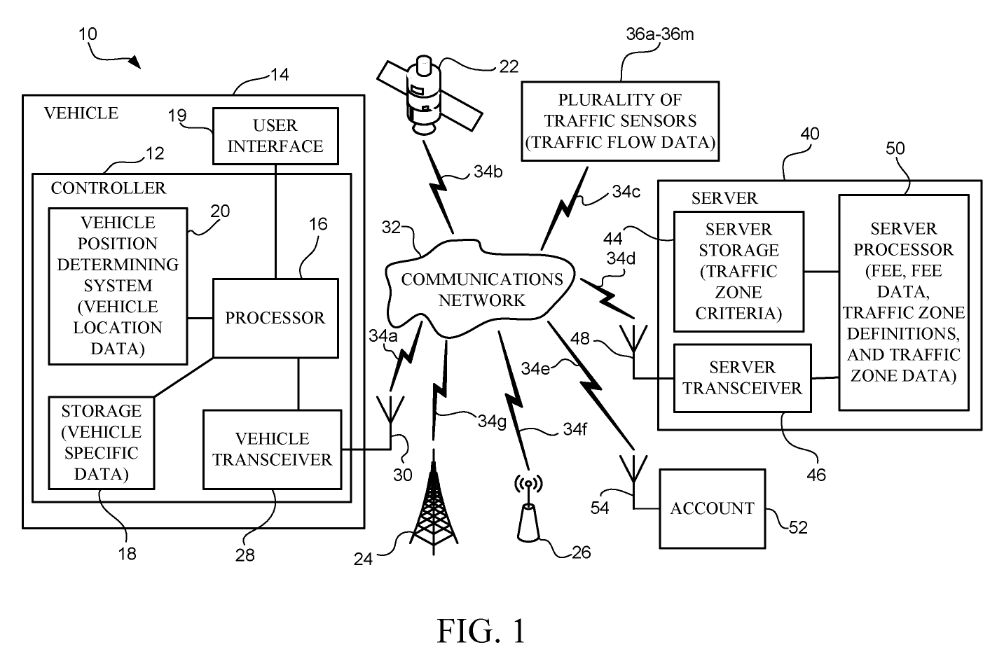

Referring initially to FIG. 1, a system 10 for traffic control is initially described. The system 10 may include a controller 12 carried by a vehicle 14 with the controller providing vehicle location data and vehicle specific data. The vehicle 14 is a car, truck, vessel, plane, train, or the like, for example.

The controller 12 includes a processor 16 or other logic circuitry which is connected to storage 18 as will be appreciated by those of skill in the art. In other embodiments, the storage 18 may be embedded in the processor 16.

In one embodiment, vehicle specific data is kept in storage 18. Vehicle specific data provides a description of the vehicle such as the vehicle's weight, the type of fuel the vehicle uses, the size of the vehicle's engine, the use of the vehicle (commercial or private), number of occupants in the vehicle, or the like, for example.

The controller 12 generates vehicle location data via a vehicle position determining system 20. The vehicle position determining system 20 may use a satellite based vehicle position determining system 22, a land based vehicle position determining system 24, and/or a sea based vehicle position determining system 26 depending on the type of vehicle 14 and where the vehicle is traveling.

An example of a satellite based vehicle position determining system 22 is the Global Positioning System (GPS), the Galileo Positioning System, or the like. An example of a land based vehicle position determining system 24 is the use of cell towers, proprietary sensors or the like to triangulate a vehicle's 14 position. An example of a sea based vehicle position determining system 26 may employ triangulation location techniques using buoys and/or land towers.

The controller 12 communicates with external systems such as the satellite based vehicle position determining system 22 via a controller transceiver 28 and a controller antenna 30 through a communication network 32, for example. The communication network 32 connects the other parts of system 10 through communication links 34a-34g as will be appreciated by those of skill in the art. The communication network 32 is a wireless network and/or a wired network.

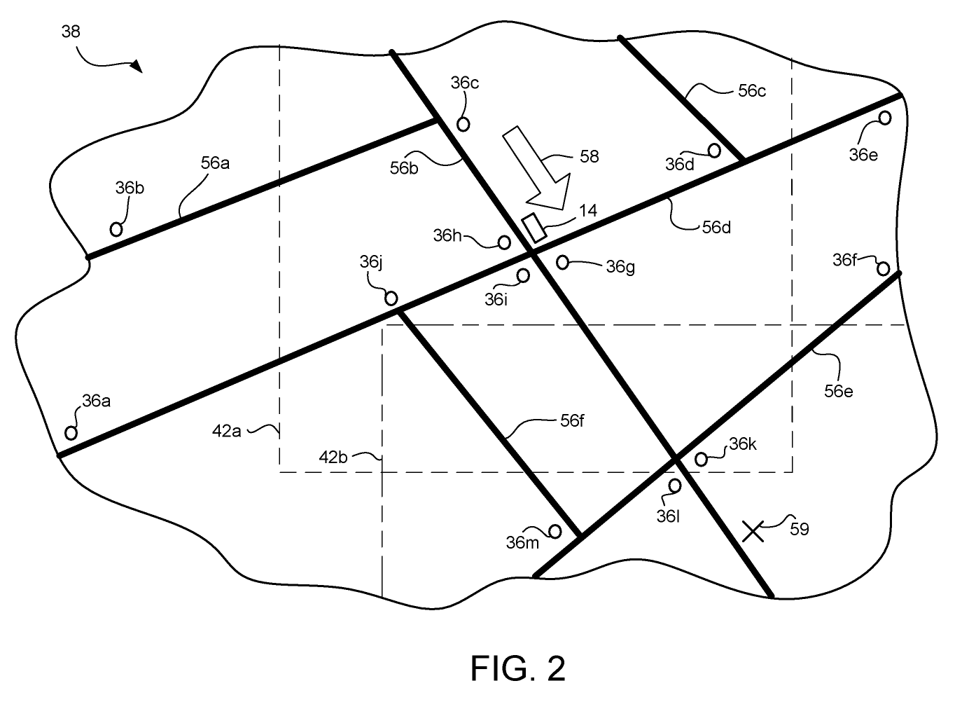

Referring now additionally to FIG. 2, which illustrates a partial schematic diagram of a road map. The system 10 further comprises a plurality of traffic sensors 36a-36m within an area 38 selectively placed along streets 56a-56f, for example. The plurality of traffic sensors 36a-36m connect to the communication network 32 thereby providing traffic flow data to a server 40 as will be appreciated by those of skill in the art.

In one embodiment, the server 40 is in communication with the controller 12, and the server defines at least one traffic zone 42a and 42b based upon the traffic flow data generated by the plurality of traffic sensors 36a-36m. In another embodiment, there is a larger number of traffic zones than just 42a and 42b.

The server 40 may further define traffic zones 42a and 42b using traffic zone criteria in server storage 44 such as the distance traveled by the vehicle 14 through the traffic zones, the amount of time the vehicle spends in the traffic zones, what day the vehicle is in the traffic zone, what time of day the vehicle is in the traffic zone, what is the identity of the driver, what class of driver is operating the vehicle, what impact the vehicle has on the traffic zone e.g. did the vehicle violate a traffic rule or cause an accident, the consideration of any construction restrictions within the traffic zone, the consideration of any emergency situations within the traffic zone, consideration of any special event happening within the traffic zone, or the like, for example. As a result, the traffic zones 42a and 42b can be added, deleted, modified, enlarged, reduced, or moved to reflect real-time conditions within the traffic zones.

In one embodiment, the traffic zones 42a and 42b are polygons and are defined using longitude and latitude coordinates. This simplifies location-based charging because it is not necessary to determine a road segment that the vehicle 14 is traveling on. In other embodiments, the traffic zones 42a and 42b may be irregularly shaped and/or defined by real world physical parameters such as roads as will be appreciated by those of skill in the art.

The server 40 also includes a server processor 50 or other logic circuitry which is connected to server storage 44 as will be appreciated by those of skill in the art. In other embodiments, the server storage 44 may be embedded in the server processor 50. The server 40 further includes a server transceiver 46 that is connected to a server antenna 48.

The server 40 uses at least one of the traffic zones 42a and 42b along with the vehicle location data and vehicle specific data to determine a fee for the vehicle 14 to operate within a particular traffic zone. For instance, vehicle 14 in FIG. 2 is traveling along street 56b in traffic zone 42a and in the direction of arrow 58. As a result, server 40 determines the fee the operator of vehicle 14 is charged for driving in traffic zone 42a under the conditions and restrictions at that time thereby exerting real-time, market based control on road usage within the traffic zone.

In one embodiment, the server 40 charges an account 52 associated with the controller to pay the fee. The account 52 may be a cellular telephone account, a credit card account, a pre-funded account, or the like. The account 52 connects to the communications network 32 through an account antenna 54.

In another embodiment, the operator of the vehicle 14 is notified of the fee charged to the account 52 through user interface 19 carried by the vehicle and the notification may be in real-time. The user interface 19 may be a Telematics-type terminal or the like. Alternatively, the user interface 19 may be a device connected to the communications network 32 via a wireless communications link such as a cellular telephone, personal digital assistant, or the like.

In another embodiment, the server 40 provides fee data based upon current traffic zone data to the controller 12 prior to the vehicle 14 entering the traffic zone 42b (FIG. 2) thereby permitting the operator of the vehicle to either enter or avoid the traffic zone. In other words, the system 10 may influence where the vehicle 14 travels due to the cost associated with different routes through the area 38.

In yet another embodiment, the server 40 monitors the traffic zones 42a and 42b and changes in real-time the fee for the vehicle 14 based upon a real-time change in the traffic flow data. For instance, if there is an accident 59 in the traffic zone 42b, the server 40 may raise the fee within the traffic zone to make travel through that traffic zone undesirable for most vehicle 14 operators because of the cost.

Continuing with the above example, the server 40 may monitor the traffic zone 42b and dynamically changes how the traffic zone is defined based upon a real-time change in the traffic flow data. Stated another way, when the server 40 determines the accident 59 has been cleared, the server may reduce the fee for the vehicle 14 to travel through the traffic zone 42b. The ability of system 10 to make a real-time adjustment of the fee in view of real-time traffic flow data enables the system to excel at traffic control.

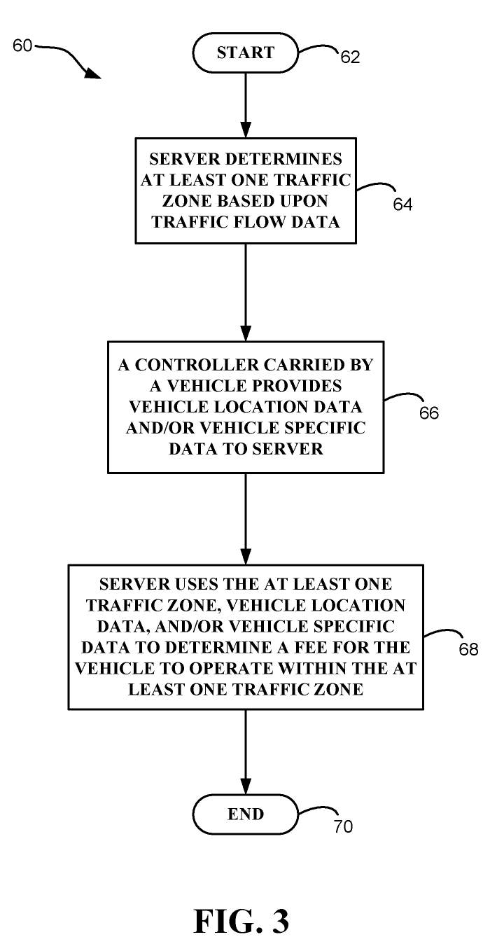

Another aspect of the invention is directed to a method for traffic control, which is now described with reference to flowchart 60 of FIG. 3. The method begins at Block 62 and may include defining at least one traffic zone 42a and 42b based upon traffic flow data in the server 40 at Block 64. The method may also include determining vehicle location data and vehicle specific data by a controller 12 carried by a vehicle 14 at Block 66. The method may further include using the at least one traffic zone 42a and 42b along with the vehicle location data and vehicle specific data at the server 40 to determine the fee for the vehicle 14 to operate within the at least one traffic zone at Block 68. The method ends at Block 70.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A system for traffic control comprising:
a controller carried by a vehicle, said controller providing vehicle location data and vehicle specific data; and
a server in communication with said controller, said server defining at least one traffic zone based upon traffic flow data, and said server using the at least one traffic zone along with the vehicle location data and vehicle specific data to determine a fee for the vehicle to operate within the at least one traffic zone.

2. The system of claim 1 wherein said server charges an account associated with said controller to pay the fee.

3. The system of claim 1 wherein said server provides fee data based upon current traffic zone data to said controller prior to the vehicle entering the at least one traffic zone thereby permitting an operator of the vehicle to either enter or avoid the at least one traffic zone.

4. The system of claim 1 wherein said server monitors the at least one traffic zone and changes in real-time the fee for the vehicle based upon a real-time change in the traffic flow data.

5. The system of claim 1 wherein said server monitors the at least one traffic zone and dynamically changes how the at least one traffic zone is defined based upon a real-time change in the traffic flow data.

6. The system of claim 1 wherein said server further determines the fee for the vehicle using at least one traffic zone criteria of distance traveled by the vehicle through the at least one traffic zone, amount of time the vehicle spends in the at least one traffic zone, what day the vehicle is in the at least one traffic zone, what time of day the vehicle is in the at least one traffic zone, what impact the vehicle has on the at least one traffic zone, and consideration of special events happening within the at least one traffic zone.

7. The system of claim 1 wherein said controller generates vehicle location data via at least one of a satellite based vehicle position determining system, a land based vehicle position determining system, and a sea based vehicle position determining system.

8. The system of claim 1 further comprising a plurality of traffic sensors in communication with said server, said plurality of traffic sensors providing the traffic flow data.

9. A method for traffic control, the method comprising:
defining at least one traffic zone based upon traffic flow data in a server;
determining vehicle location data and vehicle specific data with a controller carried by a vehicle; and
using the at least one traffic zone along with the vehicle location data and vehicle specific data at the server to determine a fee for the vehicle to operate within the at least one traffic zone.

10. The method of claim 9 further comprising charging an account associated with the controller to pay the fee via the server.

11. The method of claim 9 further comprising providing fee data that is based upon current traffic zone data through the server to the controller prior to the vehicle entering the at least one traffic zone thereby permitting an operator of the vehicle to either enter or avoid the at least one traffic zone.

12. The method of claim 9 further comprising monitoring the at least one traffic zone through the server and changing the fee for the vehicle based upon a real-time change in the traffic flow data.

13. The method of claim 9 further comprising monitoring the at least one traffic zone through the server and dynamically changing how the at least one traffic zone is defined based upon a real-time change in the traffic flow data.

14. The method of claim 9 further comprising determining the fee for the vehicle further through the server using at least one of distance traveled by the vehicle through the at least one traffic zone, amount of time the vehicle spends in the at least one traffic zone, what day the vehicle is in the at least one traffic zone, what time of day the vehicle is in the at least one traffic zone, what impact the vehicle has on the at least one traffic zone, and consideration of special events happening within the at least one traffic zone.

15. The method of claim 9 further comprising generating vehicle location data at the controller via at least one of a satellite based vehicle position determining system, a land based vehicle position determining system, and a sea based vehicle position determining system.

16. The method of claim 9 further comprising providing the traffic flow data via a plurality of traffic sensors to the server.

17. A computer program product embodied in a tangible media comprising:
computer readable program codes coupled to the tangible media for traffic control, the computer readable program codes configured to cause the program to:
define at least one traffic zone based upon traffic flow data in a server;
determine vehicle location data and vehicle specific data with a controller carried by a vehicle; and
use the at least one traffic zone along with the vehicle location data and vehicle specific data at the server to determine a fee for the vehicle to operate within the at least one traffic zone.

18. The computer program product of claim 17 further comprising program code configured to: provide through the server fee data that is based upon current traffic zone data to the controller prior to the vehicle entering the at least one traffic zone thereby permitting an operator of the vehicle to either enter or avoid the at least one traffic zone.

19. The computer program product of claim 17 further comprising program code configured to: monitor the at least one traffic zone through the server and change the fee for the vehicle based upon a real-time change in the traffic flow data.

20. The computer program product of claim 17 further comprising program code configured to: monitor the at least one traffic zone through the server and dynamically changing how the at least one traffic zone is defined based upon a real-time change in the traffic flow data.
